(19) United States
(12) Patent Application Publication
(10) Pub. No.: US 2006/0015523 A1
(43) Pub. Date: Jan. 19, 2006

(54) System and method for accessing document data via a web service

(75) Inventors: Andrea Dick, Princeton, NJ (US); Thomas Angle, Newtown, PA (US); Edward Blazejewski, Yardley, PA (US); Joseph Kenney, Burlington Twp., NJ (US); Chao-Hen Kuo, Devon, PA (US); Robert Molloy, Delran, NJ (US)

Correspondence Address: BAKER BOTTS L.L.P., 2001 ROSS AVENUE, SUITE 600, DALLAS, TX, 75201-2980, US

(73) Assignee: COMPUTER ASSOCIATES THINK, INC.

(21) Appl. No.: 11/042,572

(22) Filed: Jan. 24, 2005

Related U.S. Application Data
(63) Continuation of application No. 10/818,224, filed on Apr. 5, 2004, now abandoned.
(60) Provisional application No. 60/460,717, filed on Apr. 4, 2003.

(30) Foreign Application Priority Data
Apr. 5, 2004 (WO) PCT/US04/10393

(51) Int. Cl. G06F 17/00

(52) U.S. Cl. 707/102

(57) ABSTRACT

A method for accessing document data via a web service is disclosed which includes receiving a request from a client application. The request for document data to be retrieved from a repository managed by an IDARS/DOM application. The method also includes processing the request including creating and transmitting at least one access request to the IDARS/DOM application, and receiving document data in response to each transmitted access request. The method further includes formatting the document data received from the IDARS/DOM application. The method still further includes transmitting the formatted document data to the client application. Apparatus, systems and articles of manufacture for accessing document data via a web service are also disclosed.

### CROSS-REFERENCE TO RELATED APPLICATIONS

This application claims priority to U.S. Provisional Application entitled “System and Method for Accessing Document Data via a Web Service”, Ser. No. 60/460,717, filed Apr. 4, 2003, which is hereby incorporated by reference in its entirety.

### TECHNICAL FIELD

The described systems and methods are generally related to information processing environments in which document distribution, archival and retrieval are managed. More specifically, the described systems and methods are related to accessing document content via a web service.

### BACKGROUND

Enterprises often employ large, complex, computing environments that include a number of enterprise components such as servers, routers, databases, repositories, mainframes, personal computers, business applications and enterprise management software, for example. Such enterprises may have a desire to create, capture, deliver, customize and/or manage immense volumes and types of content across the enterprise in support of one or more business processes.

Some enterprises manage content within the enterprise using integrated document archive and retrieval systems (“IDARS”) and/or distributed output management (“DOM”) software. IDARS and DOM systems help manage documents destined for print. Such systems efficiently enable businesses to conserve resources, for example, by storing single copies of documents electronically instead of printing multiple copies per person or storing them in a hardcopy form; both of which can require paper and long term storage facilities or services. Examples of typical IDARS functions include archiving, indexing, accessing, viewing, capturing and/or printing document content. DOM software typically enables management of document delivery and/or distribution.

Certain prior art IDARS and DOM applications provide proprietary programming interfaces to enable users to access the content stored in repositories managed by a particular application. Such prior art applications have several shortcomings. One shortcoming, for example, is that client programs of prior art IDARS and DOM applications are required to operate on specific hardware or software platforms, such as Windows NT, or Unix, for example.

Another shortcoming of prior art IDARS and DOM applications is that the proprietary programming interfaces are not designed to operate over the Internet. Yet another shortcoming of prior art IDARS and DOM applications is that the proprietary programming interfaces are limited to accessing data managed by the specific IDARS or DOM application providing the programming interface, and are not capable of accessing document content or data managed by other IDARS or DOM applications.

Still another shortcoming of prior art IDARS or DOM applications is that the proprietary programming interfaces of such applications require client applications to be written in particular programming languages. Further, the proprietary programming interfaces of prior art IDARS and DOM applications require all input and output parameters to be identified prior to processing a request for data.

The described system is a web service. The input and output parameters of the web service may be defined in an industry standard format such as “Web Service Description Language. (“WSDL”)” Client applications that will use the web service to retrieve data use the Web Service Description Language for the web service to identify, for example, the web service requests, the location of the web service and input and output parameters. Further, the WSDL for a deployed web service can be accessed via Universal Description, Discovery and Integration (“UDDI”). UDDI is a directory service that provides a way to describe web services such that client applications can discover and make calls to them. Similar to WSDL, UDDI is an industry standard currently defined by the Oasis standards consortium. Information regarding UDDI can be found at WWW.UDDI.ORG. Web Service Definition Language is also an industry standard and is defined by the World Wide Web Consortium (“W3C”).

Consequently, there is a need for methods and systems that address the shortcomings of prior art IDARS and DOM applications and provide platform-neutral, application-neutral, programming language-neutral, dynamic, access to repositories over the Internet.

### SUMMARY

The following presents a simplified summary of methods, systems, and computer readable media associated with accessing document data via a web service. This summary is not an extensive overview and is not intended to identify key or critical elements of the methods, systems, and/or media or to delineate the scope of the methods, systems, and media. It conceptually identifies the methods, systems, and media in a simplified form as a prelude to the more detailed description that is presented later.

According to one example aspect of the present application, a method for accessing document data via a web service is disclosed which includes receiving a request from a client application. The request for document data to be retrieved from a repository managed by an IDARS/DOM application. The method also includes processing the request including creating and transmitting at least one access request to the IDARS/DOM application, and receiving document data in response to each transmitted access request. The method further includes formatting the document data received from the IDARS/DOM application. The method still further includes transmitting the formatted document data to the client application. Apparatus, systems and articles of manufacture for accessing document data via a web service are also disclosed.

According to a second example aspect of the present application, a system for accessing document data via a web service is disclosed. The system includes a client application operative to transmit a web service request. The client application is further operative to receive a web service request response. The system also includes a web service operative to receive the web service request from the client application, create a corresponding document access request and transmit the document access request to an IDARS/DOM system. The web service is further operative to receive document content and document data from the IDARS/DOM system, format the received document content and document data, and transmit the formatted document content and document data to the client application.

According to a third example aspect of the present application, an apparatus for accessing and providing document data is disclosed. The apparatus includes a processor and a memory coupled to the processor storing processor executable instructions to control the operation of the processor. The processor executable instructions include instructions for receiving a request from a client application. The request is for document data to be retrieved from a repository managed by an IDARS/DOM application. The processor executable instructions also include instructions for processing the request, including creating and transmitting at least one access request to the IDARS/DOM application and for receiving document data in response to each transmitted access request. The processor executable instructions further include instructions for formatting the document data received from the IDARS/DOM application, and instructions for transmitting the formatted document data to the client application.

According to a fourth aspect of the present application, a computer-readable storage medium is disclosed. The computer-readable storage medium is encoded with processing instructions for accessing and providing document data.

Certain illustrative aspects of the methods, systems, and computer readable media are described herein in connection with the following description and the annexed drawings. These aspects are indicative, however, of but a few of the various ways in which the principles of the methods, systems, and media may be employed and thus the examples are intended to include such aspects and equivalents. Other advantages and novel features may become apparent from the following detailed description when considered in conjunction with the drawings.

### BRIEF DESCRIPTION OF THE DRAWINGS

For a more complete understanding of the present methods and systems, reference is now made to the following description taken in conjunction with the accompanying drawings in which like reference numbers indicate like features and wherein:

FIG. 1 is a schematic block diagram illustrating the an example web service environment;

FIG. 2 is a schematic block diagram of an example web service; and

FIGS. 3A and 3B together represent a flow chart illustrating an example methodology for processing a web service request.

### DETAILED DESCRIPTION

Example methods, systems, and computer readable media are now described with reference to the drawings, where like reference numerals are used to refer to like elements throughout. In the following description, for purposes of explanation, numerous specific details are set forth in order to facilitate thoroughly understanding the methods and systems. It may be evident, however, that the methods and systems can be practiced without these specific details. In other instances, well-known structures and devices are shown in block diagram form in order to simplify the description.

This disclosure provides methods and systems for accessing document data using a web service. According to one exemplary method, a web service receives a web service request from a client application. The web service request identifies document data to be retrieved from a repository managed by an IDARS/DOM application. The web service processes the web service request including creating and transmitting at least one access request to the IDARS/DOM application. The web service receives document data in response to each transmitted access request and formats the document data received from the IDARS/DOM application. The web service transmits the formatted document data back to the client application. Of course, the request may indicate that the document data should be directed to a destination other than the client application. For example, a request might direct response data to be routed to a printer or to an email message. In this case, client application, may receive a response confirming the successful completion of the request.

The methods and systems described herein enable programmatic access to document content and information stored in repositories of IDARS/DOM applications via web services. In some exemplary embodiments, the web services utilize simple object access protocol (“SOAP”), an industry standard protocol defined by the World Wide Web Consortium (“W3C”). SOAP is specified in XML form and is an operating system neutral, programming language neutral, lightweight protocol used for information integration and exchange.

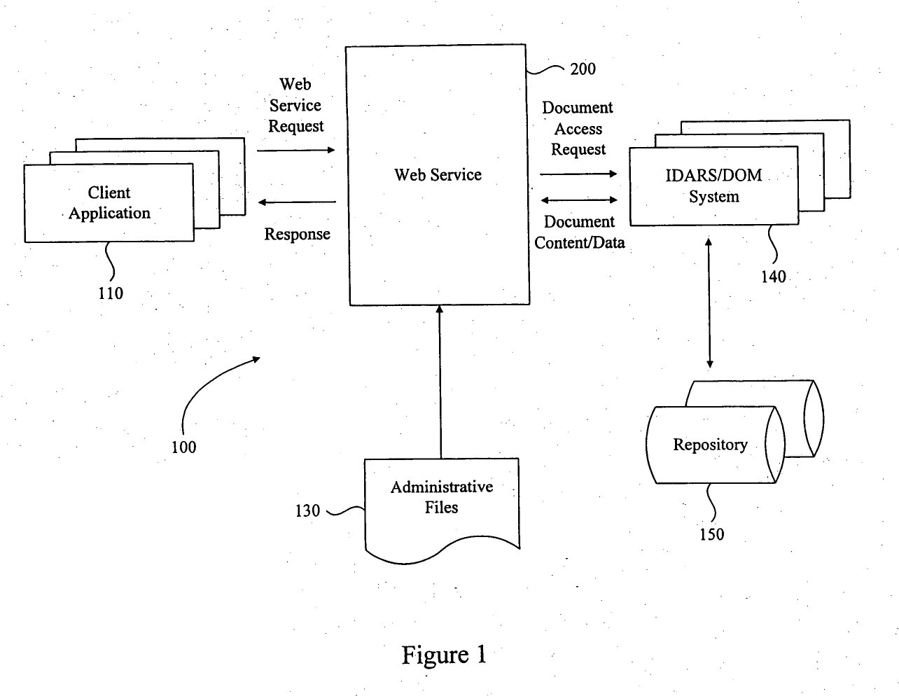

An output management web service environment 100 is illustrated in FIG. 1. Environment 100 includes a web service 200 which communicates with one or more client applications 110 which may request access to document data stored in one or more repository 150. The document data not only includes data representing the document itself, but also data about the document. The client application 110 transmits a web service request for document data to web service 200. Web service 200 processes the web service request and transmits at least one access request to IDARS/DOM system(s) 140 which are responsible for maintaining repositories 150. The access request(s) are processed by IDARS/DOM system(s) 140 which return the requested document data to web service 200. In one embodiment, requests passed to and/or from the web service to the IDARS/DOM system include userid and password data which are used to determine whether the web service request for data can access that data. This provides security restricting access to documents in the repository to authorized users Web service 200 formats the document data and transmits the formatted data to the requesting client application 110 in response to the original web service request.

Web service 200 may refer to one or more administrative files 130 for instructions regarding the processing of requests from client application 110. Administrative files 130 may include, for example, instructions for parsing web service requests, instructions for formatting access requests to be transmitted to the IDARS/DOM system(s) 140, and/or instructions for formatting document data received from the IDARS/DOM systems 140. The administrative files provide information used by the web service to process requests, and thereby control information. For example, one administrative file defines the repositories that can be accessed by the web service. If a request is received that indicates a repository that is not defined, the request will fail. Another administrative file defines the fields, and associated data types, that can be retrieved when a “report information” web service request is made.

The environment of FIG. 1 enables a client application 110 to programmatically access the document content and data of repositories 150 using web service 200. In an exemplary embodiment, the requests and responses between client application 110 and web service 200 are SOAP based. A protocol such as SOAP enables the communication between client application 110 and web service 200 to occur over the Internet, enabling the integration, administration and management of the content of repositories 150, otherwise accessible only directly using the IDARS/DOM systems 140. The client application 110 creates a SOAP encoded message. Embedded within the SOAP message is XML data that includes the parameters specific for a particular requested web service function. Each web service function has a predefined set of parameters. In the exemplary embodiment, the formatted document data is returned to the client application 110 as a SOAP encoded message.

Enabling indirect access to repositories 150 over the Internet enables the development of applications for home users, business partners, as well as internal employees that extract and display document content and data stored in repositories 150. Such Internet access also enables the creation of applications that move document content and data from outside sources into the repositories 150 without interfacing directly with IDARS/DOM systems 140. Such Internet access further enables administrative actions such as, for example, report definition and index definition to take place remotely.

IDARS/DOM systems 140 may store content in a variety of formats. Some data formats are print data formats such as advanced function printing (“AFP”) for printing on z/OS attached all-points-addressable printers or Xerox for printing on z/OS attached Xerox printers. Such print data formats work well for printing but are not compatible for display on a PC monitor, in a web browser or for integration into another application. Accordingly, exemplary web service 200 may provide the ability to transform the data retrieved form repositories 150 into other document types such as PDF, XML or HTML.

The exemplary web service 200 exposes or provides several functions to client application 110 as web services. Such web services perform one of three general types of functions: content-related functions, web service administrative or IDARS/DOM administrative functions.

A web service that performs a content-related function may return a variety of types of content management information and data retrieved from repositories 150. Examples of content-related functions include:
Report Information Returns a list of attributes for one or more reports retrieved from repositories 150.
Report Retrieval. Returns data for a report or section of a report in repository 150.
Index Information Returns index information from repositories 150.
Execute Request Executes predefined pre-initialized pooled requests.

Web service administrative functions enable management and control of the web service. Examples of administrative functions include:
Repository Service Performs repository services including managing the definition file which identifies the repositories supported by the web service.
Generate Report List DD Generates a data dictionary used by the report list web service.

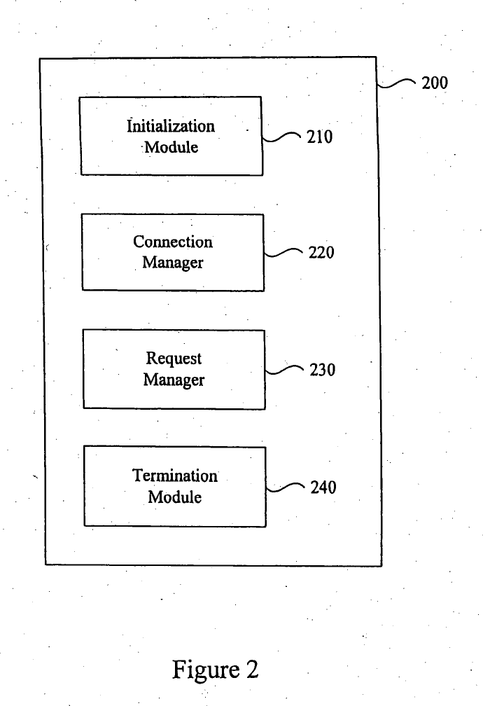

Referring to FIG. 2, there is illustrated a more detailed representation of web service 200. As illustrated, the web service 200 includes an initialization module 210, a connection manager 220, a request manager 230 and a termination module 240. In addition to processing web service requests, the exemplary output management web service employs initialization module 210 and termination module, 240 to perform initialization and termination functions, respectively. Initialization module 210 executes any one-time start up activities and is performed once for the web service installation. Web service initialization occurs upon receiving the first web service request. Until the initialization function is completed, no other web service requests may be processed. In an alternate embodiment, the initialization module 210 may be executed when the web server is started rather than when the first request is received. Once the web service initialization function is completed, the web service is ready to receive and process additional web service requests. The initialization module 210 starts connection manager 220 and request manager 230 and reads into memory all administrative files required for web service processing.

The web service termination module operates to shut down or terminate all activities for a web service installation and is executed prior to a shutdown of a server where the output management web service is deployed. The termination module 240 shuts down the connection manager 220 and request manager 230.

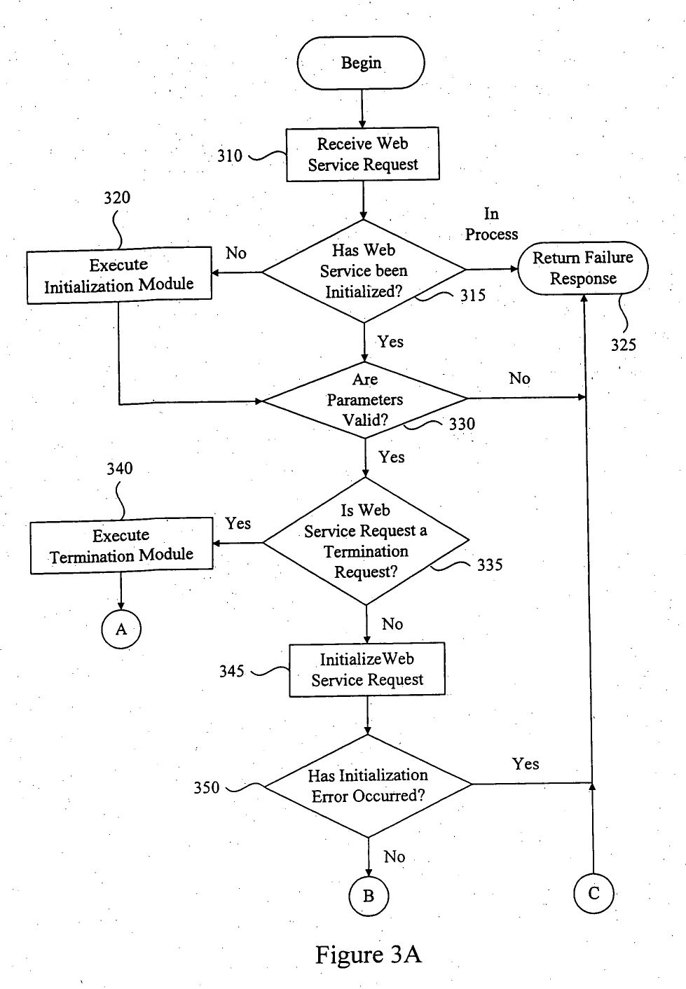

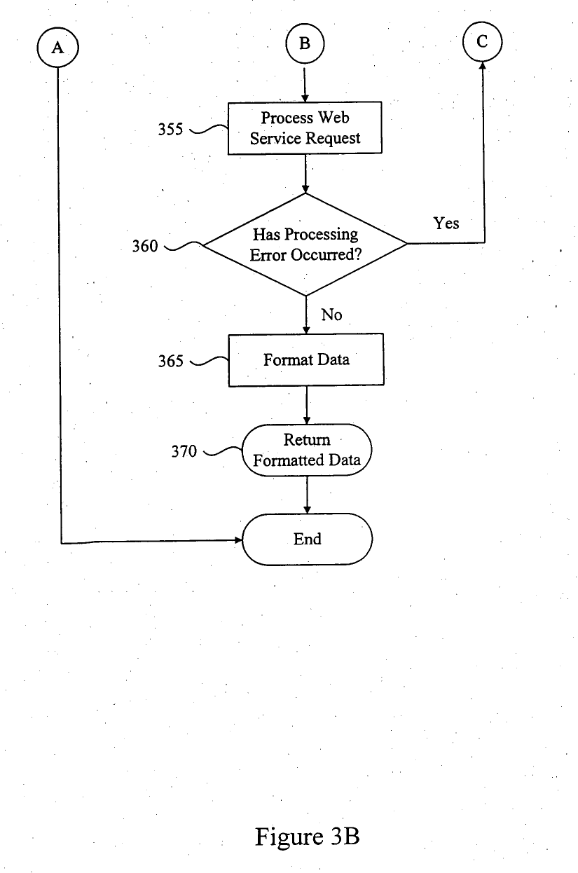

FIG. 3 is a flowchart illustrating example processing steps executed in response to a web service request. At block 310, a web service request is received by the output management web service. If the initialization module of the web service has not been started, the initialization module is executed (320). If the initialization module of the web service has been started but has not completed processing, a failure response is returned (325) to the requesting client application. If the initialization module has completed processing, flow proceeds to decition block 330.

Decision block 330 directs the processing flow based on whether the parameters of the received web service request are valid. If any of the parameters of the received web service request are not valid, processing is directed to block 325, and a failure response is returned to the requesting client application. Otherwise, the web service request is examined to determine whether it is a request for termination of the web service (335). If the request is a request to terminate the web service, the termination module is executed (340). Otherwise, a request initialization is performed at block 345. If an error is detected at block 350, processing flow is directed to block 325, and a failure response is returned to the requesting client application. Otherwise the request processing occurs at block 355, shown on FIG. 3B.

At block 360, if an error occurred during the processing of the web service request, processing is directed to block 325, and a failure response is returned to the requesting client application. Otherwise, the retrieved data is formatted at block 265. At block 370 the formatted document data and processing control is returned to the client application in response to the web service request

Examples of web service functions are described in greater detail below:

Report Information

The “Report Information” web service function returns information about one or more reports stored in a repository of an IDARS/DOM application. A client application sends a SOAP message with the request parameters for this web service. One of those parameters is a list of “fields”. Another parameter is the selection criteria to be used to select one or more reports. The web service returns a response that includes data for each field for the reports in the repository that meet the specified criteria. Report selection can specify cross report index names and values, and the information provided for these two criteria may be used to select one or more matching reports.

Report Retrieval

The “Report Retrieval” web service function returns the data for a report or a section of a report held in a repository, Report retrieval returns text and binary data, such as AFP and XEROX for example. Page ranges for text reports may be specified where applicable.

The Report Retrieval web service function returns:
Report Data—Report data returned is one of the following types Text, Binary, AFP or XEROX, for example.
   Index Information

The “Index Information” web service function returns index information for document content that resides in the repositories of the IDARS/DOM application. This web service function will respond with a failure response if the underlying IDARS/DOM application does not provide indexing capabilities.

Indices represent index values within a single report. Cross Report Indices represent index values that occur within more than one report. IDARS/DOM applications may support indexing or both indexing and cross report indexing or neither.

The Index Information Web service provides the following information:
Index Names—returns a list of index names for a specified report.
Index Values—returns a list of index values for a specified report. Each value returned represents a section of the report matching an index values.
Cross Report Index names—returns a list of cross report index names defined for a repository of an IDARS/DOM Application.
Cross Report Index Value—returns a list of cross report index values for reports accessible by a cross report index name with a specific value. The values returned represent a section of a report referenced by the index name and value specified.
   Execute Request

Pooled Requests allow for the execution of pre-defined pre-initialized requests from a request pool. Administrative functions are provided for defining request definitions and pool constraints. Constraints are values such as minimum number of requests, minimum to have available, what to do when the maximum is reached. Upon Web Service initialization, the request definitions are read and request pools are created.

The “Execute Request” web service function is used to execute a request from a pool. This web service function allows the client application to specify parameter values that tailor the request. For example, a pooled request to retrieve cross report index values for banking statements could be established. The client application request for this web service would include an account number to be used as the “value” selected by the request.

Generate Report List Data Dictionary

This web service function generates an XML data dictionary file with an entry for each repository defined to the web service. Each entry, per repository, includes a list of fields supported on “Report Information” and “Report Retrieval” web service requests for that repository. Data type information for each field is included. The information in this file is used when “Report Information” web service requests are made to verify the validity of the fields specified and to use data type information when building requests to retrieve information from repositories.

The report list data dictionary file generated by this web service function is saved in a file. The file can then be referenced in an Output Management web service configuration file. At web service initialization the file name may be extracted from the configuration file and its contents be read into memory. This web service is primarily administrative, and client programs are not expected to call it directly.

Repository

The “Repository” web service function provides the ability to create, update and maintain a repository definition file used by the Output Management web service. The repository definition file is processed when the web service initializes. The entries in the file define the IDARS/DOM repositories that can be accessed by the web service.

The “Repository” web service provides functions to manage entries in the web service definition file. These functions are primarily administrative, and the client programs are not expected to call it directly.
Insert—adds an entry to the repository definition file.
Retrieve—returns the contents of an entry; the name associated with the repository entry must be specified as input on this request. It is used to identify the entry to be retrieved.
RetrieveAll—returns the entire contents of the repository definition file
Delete—removes an existing entry from the repository definition file; the name associated with the repository entry must be specified as input on this request. It is used to identify the entry to be deleted.

From the above description, those skilled in the art will perceive improvements, changes and modifications in the described methods and systems. Such improvements, changes and modifications within the skill of the art are intended to be covered by the present application.

Accordingly, it is to be understood that the drawings and description in this disclosure are proffered to facilitate comprehension of the methods, systems and computer readable media, and should not be construed to limit the scope thereof. It should be understood that various changes, substitutions and alterations can be made without departing from the spirit and scope of the disclosure.

What is claimed is:

1. A method for accessing document data via a web service, comprising:
receiving a request from a client application, the request for document data to be retrieved from a repository managed by an IDARS/DOM application;
processing the request including creating and transmitting at least one access request to the IDARS/DOM application and receiving document data in response to each transmitted access request;
formatting the document data received from the IDARS/DOM application; and
transmitting the formatted document data to the client application.

2. The method of claim 1, wherein the request for document data is received over the Internet.

3. The method of claim 1, wherein the request for document data is formatted to comply with simple object access protocol.

4. The method of claim 1, wherein the response is formatted to comply with simple object access protocol.

5. The method of claim 1, wherein the request is a request to access information describing at least one report stored in the repository.

6. The method of claim 1, wherein the request is a request to retrieve a report stored in the repository.

7. The method of claim 1, wherein the request is a request to retrieve index information relating to document content stored in the repository.

8. The method of claim 1, wherein the request is a request to execute a predefined request.

9. The method of claim 1, wherein the request is a request to manage the repository.

10. The method of claim 1, further comprising initializing the web service.

11. The method of claim 1, further comprising terminating the web service.

12. The method of claim 1, wherein formatting includes transforming the document data from one type to another.

13. A system for accessing document data via a web service, comprising:
a client application, the client application operative to transmit a web service request, the client application further operative to receive a web service request response; and
a web service, the web service operative to receive the web service request from the client application, create a corresponding document access request and transmit the document access request to an IDARS/DOM system, the web service further operative to receive document content and document data from the IDARS/DOM system, format the received document content and document data, and transmit the formatted document content and document data to the client application.

14. An apparatus for accessing and providing document data, comprising:
a processor;
a memory coupled to the processor storing processor executable instructions to control the operation of the processor;
the processor executable instructions including:
instructions for receiving a request from a client application, the request for document data to be retrieved from a repository managed by an IDARS/DOM application;
instructions for processing the request including creating and transmitting at least one access request to the IDARS/DOM application and receiving document data in response to each transmitted access request;
instruction s for formatting the document data received from the IDARS/DOM application; and
instructions for transmitting the formatted document data to the client application.

15. A computer-readable storage medium encoded with processing instructions for accessing and providing document data, comprising:
computer readable instructions for receiving a request from a client application, the request for document data to be retrieved from a repository managed by an IDARS/DOM application;
computer readable instructions for processing the request including creating and transmitting at least one access request to the IDARS/DOM application and receiving document data in response to each transmitted access request;
computer readable instructions for formatting the document data received from the IDARS/DOM application; and
computer readable instructions for transmitting the formatted document data to the client application.
